(19) United States
(12) Patent Application Publication
(10) Pub. No.: US 2023/0118424 A1
(43) Pub. Date: Apr. 20, 2023

(54) MAGNETICALLY BIASED VALVE, SYSTEM, AND METHOD

(71) Applicants: Jose Rafael Gonzalez, Fulshear, TX (US); Oscar Becerra Moreno, Houston, TX (US)

(72) Inventors: Jose Rafael Gonzalez, Fulshear, TX (US); Oscar Becerra Moreno, Houston, TX (US)

(73) Assignee: Baker Hughes Oilfield Operations LLC, Houston, TX (US)

(21) Appl. No.: 17/506,158

(22) Filed: Oct. 20, 2021

(51) Int. Cl. E21B 34/14; E21B 34/08

(52) U.S. Cl. CPC E21B 34/14; E21B 34/08; E21B 2200/02; E21B 34/066

(57) ABSTRACT

A valve including a valve seat, a valve shuttle movable among positions wherein the shuttle is sealed against the seat and wherein the shuttle is spaced from the seat, a first magnet associated with the shuttle, and a second magnet positioned to magnetically interact with the first magnet in one of attractively or repulsively in at least one of the positions of the shuttle.

### BACKGROUND

In the resource recovery and fluid sequestration industries it is often necessary to produce or inject fluids through a controlling valve. Various constructions for valves exist in the arts but there are drawbacks to each and due to differing operational realities, sometimes existing valve structures drawbacks create problems for operators. In view hereof, the art will well receive additional valve structures and systems including those valve structures.

### SUMMARY

An embodiment of a valve including a valve seat, a valve shuttle movable among positions wherein the shuttle is sealed against the seat and wherein the shuttle is spaced from the seat, a first magnet associated with the shuttle, and a second magnet positioned to magnetically interact with the first magnet in one of attractively or repulsively in at least one of the positions of the shuttle.

A wellbore system including a borehole extending into a subsurface formation, a string in the borehole, and a valve disposed within or as a part of the string.

A method for controlling fluid flow including applying a cracking pressure to a valve, cracking the valve by meeting a cracking threshold pressure, and maintaining the valve in an open position with less than the cracking pressure due to the first and second magnets being in a configuration to attract to one another and the first and second magnets being farther from one another.

A method for controlling fluid flow including applying a cracking pressure to a valve, cracking the valve by meeting a cracking threshold pressure, and maintaining the valve in an open position with greater than the cracking pressure due to the first and second magnets being in a configuration to repel one another and the first and second magnets being closer from one another.

### BRIEF DESCRIPTION OF THE DRAWINGS

The following descriptions should not be considered limiting in any way. With reference to the accompanying drawings, like elements are numbered alike:

FIG. 1 is a sectional view of a first valve embodiment in a closed position;

FIG. 2 is the valve of FIG. 1 in an open position;

FIG. 3 is another valve embodiment illustrated in an open position;

FIG. 4 is yet another valve embodiment illustrated in an open position;

FIG. 5 is yet another valve embodiment illustrated in an open position;

FIG. 6 is yet another valve embodiment illustrated in an open position;

FIG. 7 is a view of the valve of FIG. 6 in a closed position;

FIG. 8 is yet another valve embodiment illustrated in an open position; and

FIG. 9 is a schematic view of a wellbore system with a valve as disclosed herein.

### DETAILED DESCRIPTION

A detailed description of one or more embodiments of the disclosed apparatus and method are presented herein by way of exemplification and not limitation with reference to the Figures.

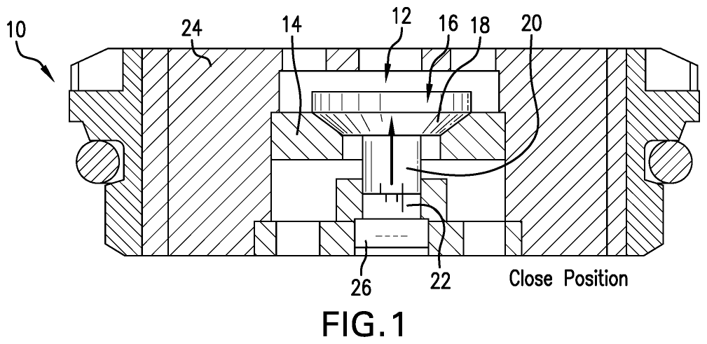

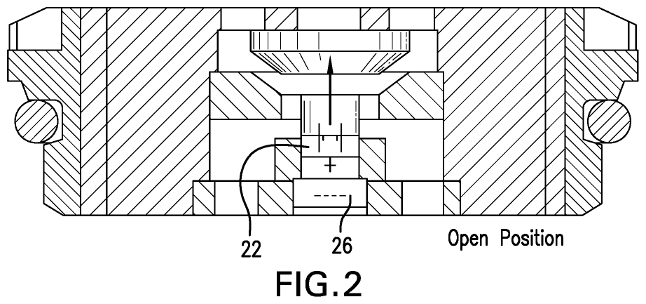

Referring to FIGS. 1 and 2, a first embodiment of a valve 10 is illustrated in closed and open positions, respectively. Valve 10 includes a shuttle 12 and a seat 14, the shuttle 12 being movable among positions where it is sealed to the seat 14 and where it is spaced from the seat 14, which allows fluid to flow past the valve 10. As the shuttle 12 moves farther from the seat 14, the flow rate will increase until the shuttle 12 reaches a position where it is physically prevented from moving farther from the seat 14. This position is illustrated in FIG. 2. Shuttle 12 comprises a head 16 including a seal face 18 and a stem 20. Seal face 18 interacts with seat 14 to prevent fluid flow therepast when valve 10 is in the closed position as shown in FIG. 2. A first magnet 22 is disposed within a hollow of or at the end of the stem 20. FIGS. 1 and 2 are meant to illustrated both possibilities since if the magnet 22 is attached to an end of the stem 20 or disposed in a hollow in that stem with a thin wall of the stem still existing about a periphery of the magnet 22, the view would look the same in the scale as shown. The seat 14 in this embodiment is disposed in a housing 24 that supports the operative portions of valve 10. Also supported in the housing 24 is a second magnet 26 positioned to interact magnetically more strongly or more weakly with the first magnet 22 depending upon a position of the shuttle 12 and polarity of the magnets 22 and 26. In FIGS. 1 and 2, magnets 22 and 26 may be positioned with polarity to attract for an injection system such that the valve 10 will stay closed with the magnets 22 and 26 immediately adjacent one another until a threshold cracking pressure is reached and the shuttle is force away from the seat. The magnetic attraction will of course attenuate with increasing distance between magnets 22 and 26 and so less hydrodynamic force is needed to maintain the valve 10 open than to open it initially. Conversely, the magnets 22 and 26 could be positioned to repel one another in which case the valve tends to remain open unless increasing hydrodynamic force on the valve 10 forces the shuttle to overcome the increasing magnetic field between the magnets as they are moved into greater proximity to one another. This may occur in situations where water breakthrough occurs and which results in much higher flow rates, thereby increasing hydrodynamic force on the shuttle 12.

Each of the embodiments disclosed herein employ the same principal of operation as the embodiment of FIG. 1. There are two magnets that are positioned either to attract one another or to repel one another depending upon which direction the operator needs the shuttle to be biased. Advantages of the embodiments include the absence of cycle fatigue that one would see if a spring were used and simplicity of the system. Each of the additional Figures portrays a similar configuration of the magnets and the shuttle and seat that will be understood by one of ordinary skill following the above disclosure and by viewing the various Figures.

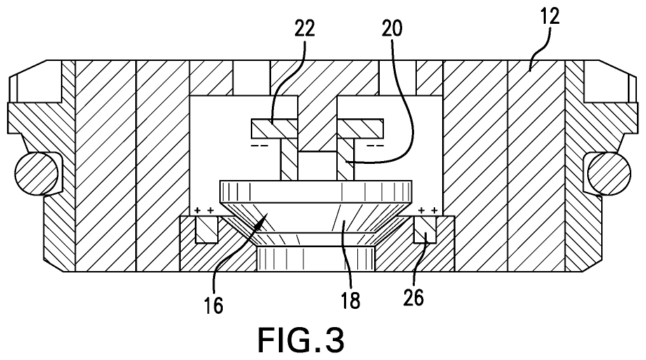

Referring to FIG. 3, another embodiment of valve 10 is illustrated that characterizes the magnets as ring shapes. The first magnet 22 still is mounted to the shuttle stem 20. The second magnet 26 is in this embodiment mounted directed to the seat 14 and in a ring shape that is of larger diametric proportions than magnet 22. This is illustrated to be clear that it is the magnetic field interaction that matters to the function of valve 10 rather than a particular shape of the magnets 22 and 26. As in the embodiment of FIG. 1, the polarity of the magnets 22 and 26 may be arranged for attraction or repulsion depending upon which directions one wishes the valve to operate, i.e. to cause valve closure or cause valve opening with the attendant field degradation with distance noted above. FIG. 3 illustrated the valve 10 in a partly open position.

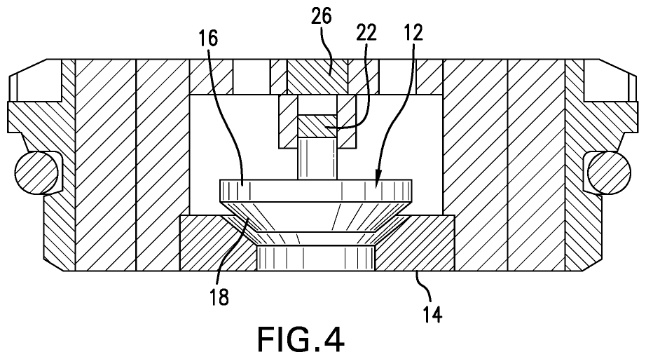

Referring to FIG. 4, yet another related configuration of valve 10 is illustrated. The relevant components are numbered identically, and the Figure illustrates the valve 10 in a partially open position. Again, the polarity of magnets 22 and 26 dictate whether the valve will be open or closed absent hydrodynamic of pressure force on the valve 10. If the magnets 22 and 26 are arranged to repel one another, the valve 10 of FIG. 4 will remain closed without applied pressure or flow and if the magnets 22 and 26 are arranged to attract one another, the valve will remain open without applied flow forcing it to close.

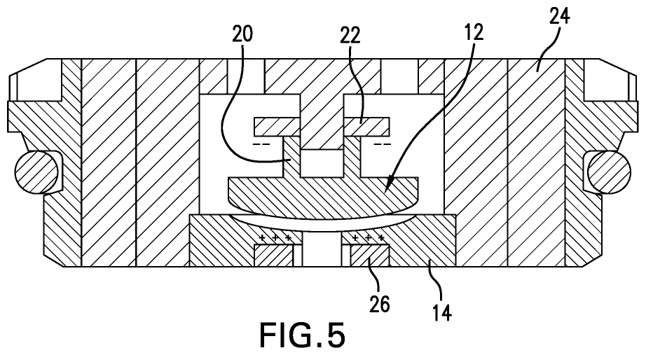

Referring to FIG. 5, yet another arrangement is illustrated. The arrangement functions as does the others and again depends upon polarity of the magnets 22 and 26. It is noted that for FIGS. 3 and 5, the arrangements will either used magnets having a greater flux density or if using magnets have the same flux density as the other embodiments, will require lower thresholds for pressure or hydrodynamic force to affect the valve since the magnets 22 and 26 in these embodiments are physically mounted farther from one another than in the other embodiments.

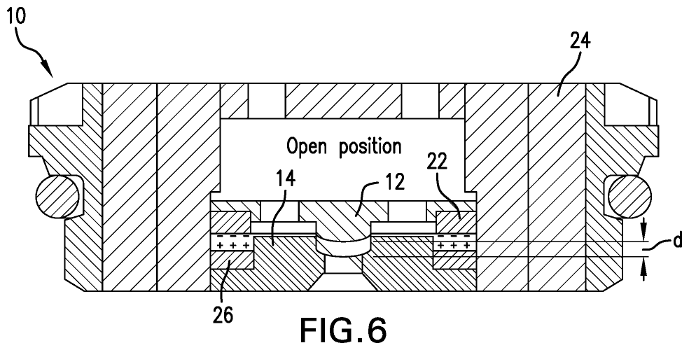

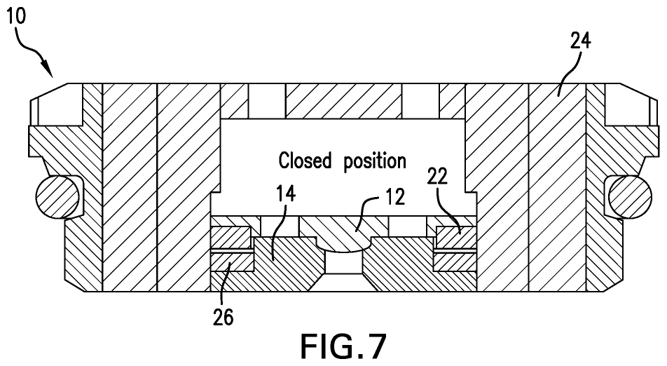

FIGS. 6 and 7 illustrated the open and closed positions of another embodiment and otherwise functions the same as the other embodiments.

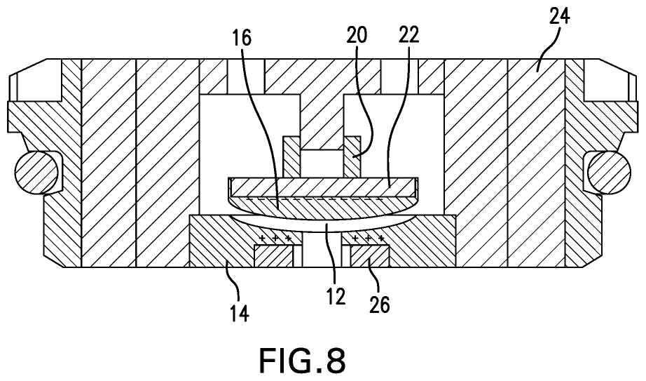

FIG. 8 is yet another embodiment that arranges magnets 22 and 26 slightly differently but also functions as do the other embodiments.

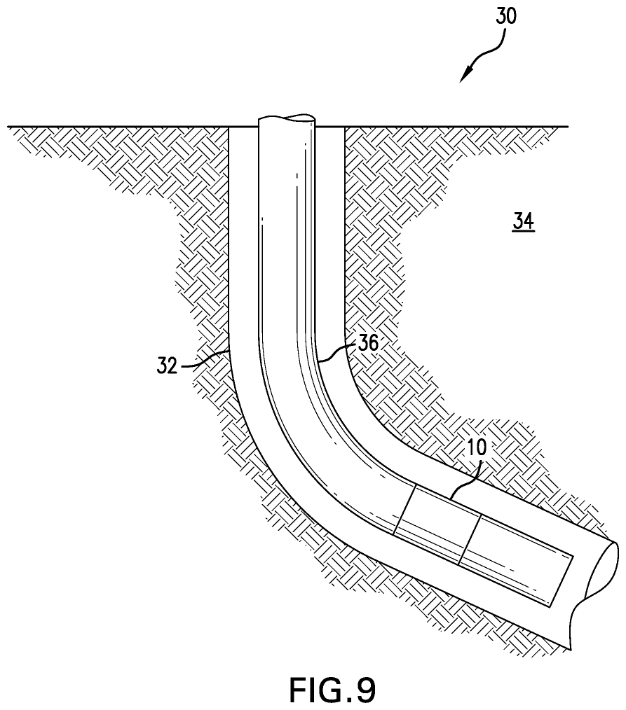

Referring to FIG. 9, a wellbore system 30 is illustrated schematically. The wellbore system 30 includes a borehole 32 in a subsurface formation 34. A string 36 is disposed in the borehole 32 and a valve 10 is disposed within or as a part of the string 36.

Set forth below are some embodiments of the foregoing disclosure:

Embodiment 1: A valve including a valve seat, a valve shuttle movable among positions wherein the shuttle is sealed against the seat and wherein the shuttle is spaced from the seat, a first magnet associated with the shuttle, and a second magnet positioned to magnetically interact with the first magnet in one of attractively or repulsively in at least one of the positions of the shuttle.

Embodiment 2: The valve as in any prior embodiment wherein the first and second magnets are arranged to be attracted to one another.

Embodiment 3: The valve as in any prior embodiment wherein the first and second magnets are arranged to be repelled from one another.

Embodiment 4: The valve as in any prior embodiment wherein the first magnet is disposed in a stem of the shuttle.

Embodiment 5: The valve as in any prior embodiment wherein the first magnet is disposed about at least a portion of the shuttle.

Embodiment 6: The valve as in any prior embodiment wherein the second magnet is disposed about at least a portion of the seat.

Embodiment 7: The valve as in any prior embodiment wherein the second magnet is disposed centrally of the seat.

Embodiment 8: The valve as in any prior embodiment wherein the first magnet is ring shaped.

Embodiment 9: The valve as in any prior embodiment wherein the second magnet is ring shaped.

Embodiment 10: A wellbore system including a borehole extending into a subsurface formation, a string in the borehole, and a valve as in any prior embodiment disposed within or as a part of the string.

Embodiment 11: A method for controlling fluid flow including applying a cracking pressure to a valve as in any prior embodiment, cracking the valve by meeting a cracking threshold pressure, and maintaining the valve in an open position with less than the cracking pressure due to the first and second magnets being in a configuration to attract to one another and the first and second magnets being farther from one another.

Embodiment 12: A method for controlling fluid flow including applying a cracking pressure to a valve as in any prior embodiment, cracking the valve by meeting a cracking threshold pressure, and maintaining the valve in an open position with greater than the cracking pressure due to the first and second magnets being in a configuration to repel one another and the first and second magnets being closer from one another.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A valve comprising:
a valve seat;
a valve shuttle movable among positions wherein the shuttle is sealed against the seat and wherein the shuttle is spaced from the seat;
a first magnet associated with the shuttle; and
a second magnet positioned to magnetically interact with the first magnet in one of attractively or repulsively in at least one of the positions of the shuttle.

2. The valve as claimed in claim 1 wherein the first and second magnets are arranged to be attracted to one another.

3. The valve as claimed in claim 1 wherein the first and second magnets are arranged to be repelled from one another.

4. The valve as claimed in claim 1 wherein the first magnet is disposed in a stem of the shuttle.

5. The valve as claimed in claim 1 wherein the first magnet is disposed about at least a portion of the shuttle.

6. The valve as claimed in claim 1 wherein the second magnet is disposed about at least a portion of the seat.

7. The valve as claimed in claim 1 wherein the second magnet is disposed centrally of the seat.

8. The valve as claimed in claim 1 wherein the first magnet is ring shaped.

9. The valve as claimed in claim 1 wherein the second magnet is ring shaped.

10. A wellbore system comprising:
a borehole extending into a subsurface formation;
a string in the borehole; and
a valve as claimed in claim 1 disposed within or as a part of the string.

11. A method for controlling fluid flow comprising:
applying a cracking pressure to a valve as claimed in claim 1;
cracking the valve by meeting a cracking threshold pressure; and
maintaining the valve in an open position with less than the cracking pressure due to the first and second magnets being in a configuration to attract to one another and the first and second magnets being farther from one another.

12. A method for controlling fluid flow comprising:
applying a cracking pressure to a valve as claimed in claim 1;
cracking the valve by meeting a cracking threshold pressure; and
maintaining the valve in an open position with greater than the cracking pressure due to the first and second magnets being in a configuration to repel one another and the first and second magnets being closer from one another.
